(19) United States
(12) Patent Application Publication
(10) Pub. No.: US 2023/0068477 A1
(43) Pub. Date: Mar. 2, 2023

(54) IMAGE FORMING APPARATUS

(71) Applicant: FUJIFILM Business Innovation Corp., Tokyo (JP)

(72) Inventors: Kenta TONOSU, Kanagawa (JP); Yosuke KASUYA, Kanagawa (JP); Takahiko KOBAYASHI, Kanagawa (JP)

(73) Assignee: FUJIFILM Business Innovation Corp., Tokyo (JP)

(21) Appl. No.: 17/589,205

(22) Filed: Jan. 31, 2022

(30) Foreign Application Priority Data
Aug. 25, 2021 (JP) 2021-137619

(51) Int. Cl. G03G 15/04

(52) U.S. Cl. CPC G03G 15/04036

(57) ABSTRACT

An image forming apparatus includes a first image forming unit including a rotatable first image carrier and a first light-emitting unit, the first light-emitting unit including a first base member and plural first light-emitting devices, the first base member extending in an axial direction of the first image carrier, the plural first light-emitting devices being provided on the first base member and being configured to apply light to an outer circumferential surface of the first image carrier; and a second image forming unit including a rotatable second image carrier and a second light-emitting unit, the second light-emitting unit including a second base member and plural second light-emitting devices, the second base member extending in an axial direction of the second image carrier, the plural second light-emitting devices being provided on the second base member and being configured to apply light to an outer circumferential surface of the second image carrier. A direction of detaching and attaching of the first light-emitting unit from and to the first image forming unit and a direction of detaching and attaching of the second light-emitting unit from and to the second image forming unit are different from each other.

### CROSS-REFERENCE TO RELATED APPLICATIONS

This application is based on and claims priority under 35 USC 119 from Japanese Patent Application No. 2021-137619 filed Aug. 25, 2021.

### BACKGROUND

### (i) Technical Field

The present disclosure relates to an image forming apparatus.

### (ii) Related Art

An image forming apparatus disclosed by Japanese Unexamined Patent Application Publication No. 2019-35972 includes an apparatus housing having an door that is movable between a closed position and an open position; an attaching object including an image carrier configured to carry an image, the attaching object being detachably attached into the apparatus housing in a direction intersecting the axial direction of the image carrier and through an opening provided in the door; an image drawing device provided facing the image carrier and configured to draw an image on the image carrier; and a guiding mechanism configured to move the image drawing device in conjunction with the opening and closing of the door, the guiding mechanism guiding the image drawing device to a drawing position when the door is closed and to a retracted position when the door is opened, the retracted position being retracted from a space provided for the attaching and detaching of the attaching object. The guiding mechanism includes a first guiding mechanism and a second guiding mechanism. While the door is moving from the closed position to a middle position defined between the closed position and the open position, the first guiding mechanism guides the image drawing device along a first guiding portion provided on the attaching object. While the door is moving from the middle position to the open position, the second guiding mechanism guides the image drawing device along a second guiding portion provided on the apparatus housing.

### SUMMARY

Aspects of non-limiting embodiments of the present disclosure relate to an image forming apparatus in which image forming units are detachable and attachable more easily than in an apparatus in which light-emitting units included in image forming units are all detachable and attachable in the same direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a first image forming unit including a rotatable first image carrier and a first light-emitting unit, the first light-emitting unit including a first base member and a plurality of first light-emitting devices, the first base member extending in an axial direction of the first image carrier, the plurality of first light-emitting devices being provided on the first base member and being configured to apply light to an outer circumferential surface of the first image carrier; and a second image forming unit including a rotatable second image carrier and a second light-emitting unit, the second light-emitting unit including a second base member and a plurality of second light-emitting devices, the second base member extending in an axial direction of the second image carrier, the plurality of second light-emitting devices being provided on the second base member and being configured to apply light to an outer circumferential surface of the second image carrier, wherein a direction of detaching and attaching of the first light-emitting unit from and to the first image forming unit and a direction of detaching and attaching of the second light-emitting unit from and to the second image forming unit are different from each other.

### BRIEF DESCRIPTION OF THE DRAWINGS

An exemplary embodiment of the present disclosure will be described in detail based on the following figures, wherein:

FIG. 1 schematically illustrates an image forming apparatus including exposure devices according to the exemplary embodiment;

FIG. 2 is a side view of a representative one of the exposure devices included in the image forming apparatus, illustrating an adjusting unit and a pressing unit that are provided on one side in the depth direction of the exposure device;

FIG. 3 is a partially sectional side view of the adjusting unit and the pressing unit included in the exposure device;

FIG. 4 is a partially sectional front view of the adjusting unit and the pressing unit included in the exposure device;

FIG. 5 is a plan view of a light-emitting unit;

FIG. 6 is a front view of the adjusting unit and the pressing unit, corresponding to FIG. 4, with the pressing unit being disabled from pressing the light-emitting unit;

FIG. 7 is a front view of the adjusting unit and the pressing unit, corresponding to FIG. 6, with the light-emitting unit being moved in a direction opposite to a direction of light emission;

FIG. 8 is a front view of the adjusting unit and the pressing unit, corresponding to FIG. 7, with the light-emitting unit being moved in a direction orthogonal to the direction of light emission;

FIG. 9 is a partially sectional front view of an adjusting unit and a pressing unit included in another representative one of the exposure devices;

FIG. 10 is a front view of the adjusting unit and the pressing unit included in the exposure device, corresponding to FIG. 9, with the pressing unit being disabled from pressing the light-emitting unit;

FIG. 11 is a front view of the adjusting unit and the pressing unit, corresponding to FIG. 10, with the light-emitting unit moved in the direction opposite to the direction of light emission; and

FIG. 12 schematically illustrates an image forming apparatus according to a modification.

### DETAILED DESCRIPTION

### Image Forming Apparatus 10

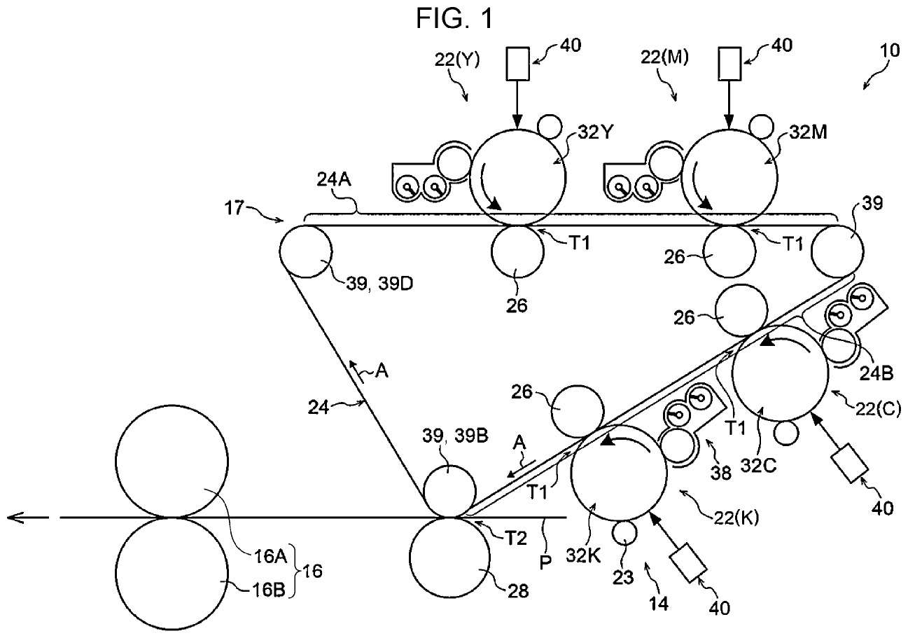

FIG. 1 schematically illustrates an image forming apparatus 10 including exposure devices 40 according to an exemplary embodiment. A configuration of the image forming apparatus 10 will first be described. Then, the exposure devices 40 included in the image forming apparatus 10 will be described. The image forming apparatus 10 forms an image composed of, for example, a plurality of colors and is a full-color printer intended for, for example, commercial printing that is to be of high image quality.

The image forming apparatus 10 is capable of handling wide recording media, P, having a width greater than the portrait width of B3 media (i.e., a width greater than 364 mm). For example, the image forming apparatus 10 is capable of handling recording media P having a width ranging from 420 mm, which is the portrait width of A2 media, to 1456 mm, which is the landscape width of B0 media, inclusive. As a specific example, the image forming apparatus 10 is capable of handling recording media P having a width of 728 mm, which is the landscape width of B2 media.

The image forming apparatus 10 illustrated in FIG. 1 is an exemplary image forming apparatus that forms an image on a recording medium. Specifically, the image forming apparatus 10 is an electrophotographic image forming apparatus that forms a toner image (an exemplary image) on a recording medium P. Toners are exemplary particles. The image forming apparatus 10 includes an image forming section 14 and a fixing device 16. Relevant elements (the image forming section 14 and the fixing device 16) of the image forming apparatus 10 will now be described.

### Image Forming Section 14

The image forming section 14 has a function of forming a toner image on a recording medium P. The image forming section 14 includes a plurality of toner-image-forming units 22 and a transfer device 17.

### Toner-Image-Forming Units 22

The plurality of toner-image-forming units 22 illustrated in FIG. 1 are provided for forming toner images in respective colors. In the present exemplary embodiment, four toner-image-forming units 22 are provided for four colors of yellow (Y), magenta (M), cyan (C), and black (K). Reference characters (Y), (M), (C), and (K) provided in FIG. 1 each indicate for which of the foregoing colors the element denoted is provided.

The toner-image-forming units 22 for the respective colors all have the same configuration, except the toners to be used. Therefore, in FIG. 1, reference signs for details are given to the toner-image-forming unit 22(K), representing all the toner-image-forming units 22.

The toner-image-forming units 22 each include a photoconductor drum 32, which is rotatable in one direction (counterclockwise in FIG. 1, for example). The photoconductor drum 32 is an exemplary image carrier. The toner-image-forming units 22 each further include a charging device 23, an exposure device 40, and a developing device 38.

In each of the toner-image-forming units 22, the charging device 23 charges the photoconductor drum 32. Furthermore, the exposure device 40 exposes the photoconductor drum 32 charged by the charging device 23 to light, thereby forming an electrostatic latent image on the photoconductor drum 32. Furthermore, the developing device 38 develops the electrostatic latent image formed on the photoconductor drum 32 by the exposure device 40 into a toner image.

The photoconductor drum 32 carrying the electrostatic latent image formed as above on the outer circumference thereof rotates to transport the electrostatic latent image to the developing device 38. Details of the exposure device 40 will be described separately below.

### Transfer Device 17

The transfer device 17 illustrated in FIG. 1 transfers toner images formed by the respective toner-image-forming units 22 to a recording medium P. Specifically, in the transfer device 17, toner images formed on the respective photoconductor drums 32 are first-transferred to a transfer belt 24 (an intermediate transfer body) in such a manner as to be superposed one on top of another, and the combination of the toner images (hereinafter simply referred to as “toner image”) is second-transferred to a recording medium P. As illustrated in FIG. 1, the transfer device 17 includes the transfer belt 24, first transfer rollers 26, and a second transfer roller 28.

The first transfer rollers 26 transfer the toner images on the respective photoconductor drums 32 to the transfer belt 24 at respective first transfer positions T1, which are defined between the photoconductor drums 32 and the respective first transfer rollers 26. In the present exemplary embodiment, a first-transfer electric field is generated between each of the first transfer rollers 26 and a corresponding one of the photoconductor drums 32. With the first-transfer electric field, the toner image formed on the photoconductor drum 32 is transferred to the transfer belt 24 at the first transfer position T1.

The transfer belt 24 receives the toner images from the respective photoconductor drums 32 by the outer circumferential surface thereof. As illustrated in FIG. 1, the transfer belt 24 has an annular shape and is positioned by being stretched around a plurality of rollers 39.

The plurality of rollers 39 include a driving roller 39D, for example. When the driving roller 39D is driven by a driving unit (not illustrated) to rotate, the transfer belt 24 circulates in a direction represented by arrow A. As illustrated in FIG. 1, the plurality of rollers 39 further include a counter roller 39B, which is positioned against the second transfer roller 28.

The second transfer roller 28 transfers the toner image on the transfer belt 24 to a recording medium P at a second transfer position T2, which is defined between the counter roller 39B and the second transfer roller 28. In the present exemplary embodiment, a second-transfer electric field is generated between the counter roller 39B and the second transfer roller 28. With the second-transfer electric field, the toner image transferred to the transfer belt 24 is transferred to a recording medium P at the second transfer position T2.

As illustrated in FIG. 1, the transfer belt 24 (an exemplary transfer member) according to the present exemplary embodiment includes a horizontal portion 24A, which extends in the horizontal direction; and an angled portion 24B, which is angled with respect to the vertical direction.

### Fixing Device 16

The fixing device 16 illustrated in FIG. 1 fixes the toner image transferred to a recording medium P by the second transfer roller 28 on the recording medium P. As illustrated in FIG. 1, the fixing device 16 includes a heating roller 16A (a heating member) and a pressing roller 16B (a pressing member). In the fixing device 16, the heating roller 16A and the pressing roller 16B apply heat and pressure to the recording medium P, thereby fixing the toner image on the recording medium P.

### Exposure Devices 40

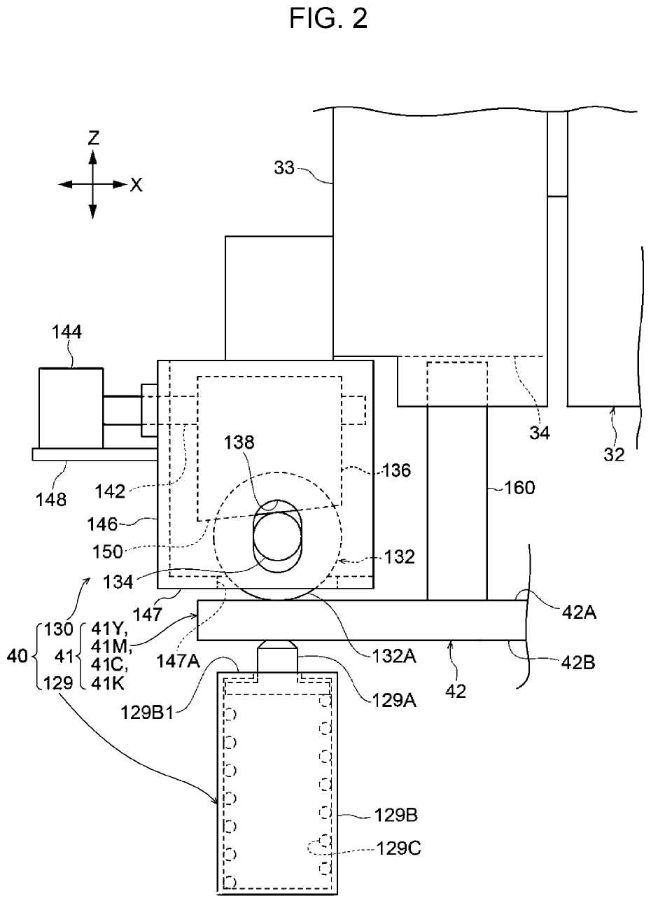

Configurations of the exposure devices 40 according to the present exemplary embodiment will now be described. FIG. 2 is a side view of a representative one of the exposure devices 40. The following description is based on a definition that, in relevant drawings, the Y axis represents the width direction of the exposure device 40 (hereinafter referred to as the device-width direction), the Z axis represents the height direction of the exposure device 40 (hereinafter referred to as the device-height direction), and the X axis represents the depth direction of the exposure device 40 (hereinafter referred to as the device-depth direction) that is orthogonal to both the device-width direction and the device-height direction. Note that the device-width direction and the device-height direction are defined for the convenience of description, and the configuration of the exposure device 40 is not limited by such directions.

First, an outline of the exposure device 40 will be described, followed by description of relevant elements included in the exposure device 40.

Referring to FIG. 2, the exposure device 40 includes a light-emitting unit 41, a position adjusting unit 130, and a pressing unit 129.

### Light-Emitting Unit 41

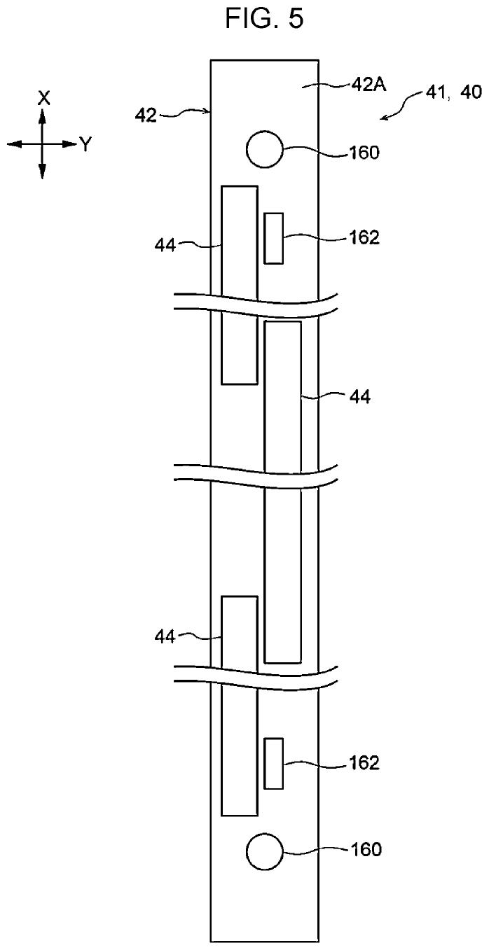

Referring to FIG. 5, the light-emitting unit 41 includes a base member 42 and a plurality of light emitters 44. The base member 42 extends in one direction (the X direction, in the present exemplary embodiment). The light emitters 44 are provided on a surface of the base member 42 that is on one side in the Z direction. In the present exemplary embodiment, three light emitters 44 are provided on the base member 42. The light emitters 44 each extend in the one direction of the base member 42. The base member 42 has a long, narrow, rectangular shape in plan view as illustrated in FIG. 5. The light emitters 44 all have the same configuration and each have a long, narrow, rectangular shape in plan view as illustrated in FIG. 5.

As an exemplary arrangement, the three light emitters 44 are staggered both in the one direction of the base member 42, i.e., in the long-side direction (the X direction) of the base member 42 and in the width direction of the base member 42 that is orthogonal to the one direction of the base member 42, i.e., in the short-side direction (the Y direction) of the base member 42. The light-emitting unit 41 extends in the axial direction of the photoconductor drum 32 (see FIG. 1). The length of the light-emitting unit 41 in the one direction is greater than or equal to the axial length of the photoconductor drum 32. At least one of the three light emitters 44 is positioned facing the surface (outer circumferential surface) of the photoconductor drum 32. Thus, light emitted from the light-emitting unit 41 is applied to the surface of the photoconductor drum 32.

If the light-emitting unit 41 has a single light emitter 44, the direction of light emission from the light-emitting unit 41 to the photoconductor drum 32 is regarded as the direction of the optical axis of the single light emitter 44. If the light-emitting unit 41 has a plurality of light emitters 44 as in the present exemplary embodiment, the direction of light emission is regarded as, seen in the one direction (X direction) of the base member 42, the direction of a virtual line extending from the midpoint between the principal points of the light emitters 44 in the short-side direction (Y direction) of the base member 42 to a point to be focused on. In the present exemplary embodiment, the position and angle of the light-emitting unit 41 are adjusted such that a virtual line extending in the direction of light emission passes through the center of the photoconductor drum 32.

In the present exemplary embodiment, the three light emitters 44 are arranged in a staggered manner in the plan view of the light-emitting unit 41 (see FIG. 5). More specifically, two of the three light emitters 44 that are at the two respective ends of the base member 42 in the one direction are positioned on one side in the short-side direction of the base member 42. The remaining one light emitter 44 in a central part of the base member 42 in the one direction is positioned on the other side in the short-side direction of the base member 42. Seen in the short-side direction of the base member 42, one end of each of the two light emitters 44 positioned on the one side in the short-side direction of the base member 42 overlaps a corresponding one of the ends of the one light emitter 44 positioned on the other side in the short-side direction of the base member 42. That is, in the one direction of the base member 42, the areas of light emission from the three respective light emitters 44 overlap one another in part.

In the present exemplary embodiment, description of elements provided for activating the light-emitting unit 41, including a driving circuit board, a power source, and wires, is omitted.

The light emitters 44 illustrated in FIG. 5 each have a plurality of light sources (not illustrated) arrayed in the one direction (X direction). The light sources according to the present exemplary embodiment include, for example, a plurality of light-emitting devices. An example of such a light source is a light-emitting-device array including a semiconductor substrate and a plurality of light-emitting devices that are arrayed in the one direction on the semiconductor substrate. The light source is not limited to such a light-emitting-device array and may be formed of a single light-emitting device. The light-emitting devices may be light-emitting diodes, light-emitting thyristors, laser devices, or the like that are arrayed in the one direction in such a manner as to achieve a resolution of, for example, 2400 dpi.

In the light-emitting unit 41, light beams emitted from the respective light sources pass through a lens unit (not illustrated) and are applied to the surface of the photoconductor drum 32 (see FIG. 1), which is the object of light application.

Referring to FIG. 2, a positioning member 160 is provided between the base member 42 and the photoconductor drum 32. The positioning member 160 determines the position of the light-emitting unit 41 with respect to the photoconductor drum 32 in a direction orthogonal to the direction of light emission. More specifically, the positioning member 160 determines the position of the light-emitting unit 41 in the Y direction, which is one of the directions that are orthogonal to the direction of light emission. In the present exemplary embodiment, the positioning member 160 is provided at each of the two ends of the base member 42 in the long-side direction (X direction) of the base member 42. FIG. 2 illustrates one of the two positioning members 160 that is provided at one of the two ends of the base member 42 in the long-side direction (X direction), specifically, on the near side in the device-depth direction.

The positioning member 160 determines the position thereof with respect to the photoconductor drum 32 in the Y direction by coming into contact with a drum flange 33. Specifically, the positioning member 160 is a round columnar projection projecting from the front surface, 42A, of the base member 42 toward the drum flange 33. The shape of the positioning member 160 is not limited to such a round columnar projection. The positioning member 160 may have any other shape such as a prism shape or an elliptic columnar shape. The positioning member 160 in the form of a round columnar projection is to be fitted into a restraining portion 34, which is provided in the drum flange 33. In the present exemplary embodiment, the drum flange 33 is one of a pair of drum flanges 33, by which the two respective axial ends of the photoconductor drum 32 are rotatably supported. The pair of drum flanges 33 are attached to an apparatus body (a frame, not illustrated, of the image forming section 14 in the present exemplary embodiment).

As illustrated in FIG. 2, the restraining portion 34 is a recess extending in the X direction. In other words, the restraining portion 34 is a groove extending in the X direction and having two open ends. When the positioning member 160 is fitted into the restraining portion 34, the positioning member 160 is restrained from moving in the Y direction by wall surfaces in the restraining portion 34 that are opposite each other in the Y direction. That is, the positioning member 160 determines the position of the light-emitting unit 41 in the Y direction by being restrained in the restraining portion 34.

Referring to FIGS. 2 to 4, the position adjusting unit 130 adjusts the distance between the light-emitting unit 41 and the photoconductor drum 32. Specifically, the position adjusting unit 130 adjusts the position of the light-emitting unit 41 with respect to the photoconductor drum 32 in a direction parallel to the direction of light emission. More specifically, the position adjusting unit 130 moves the light-emitting unit 41 in the direction parallel to the direction of light emission, thereby adjusting the position of the light-emitting unit 41 with respect to the photoconductor drum 32 in the direction parallel to the direction of light emission. In the present exemplary embodiment, the direction of light emission from the light-emitting unit 41 substantially coincides with the Z direction.

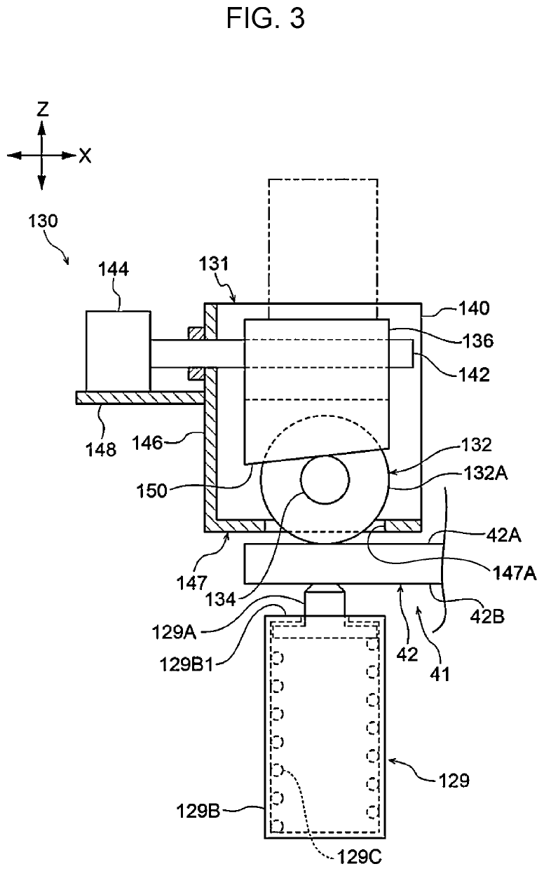

Referring to FIG. 3, the position adjusting unit 130 includes a contact member 132, a shaft 134, and a movable member 136.

As illustrated in FIG. 3, the contact member 132 has an outer circumferential surface 132A, at which the contact member 132 comes into contact with the front surface 42A of the base member 42. The contact member 132 has a disc shape and is rotatably supported by the shaft 134. Specifically, the contact member 132 is supported by the shaft 134 in such a manner as to be capable of undergoing relative rotation on the shaft 134. The contact member 132 according to the present exemplary embodiment is, for example, a ball bearing.

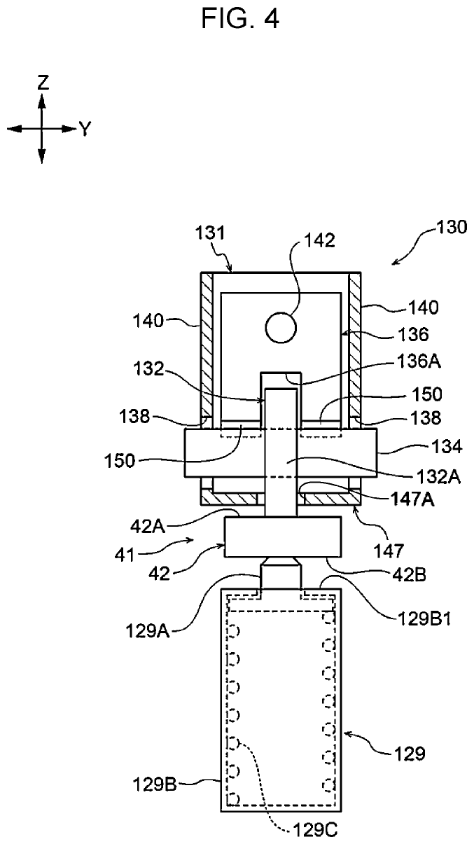

The shaft 134 supports the contact member 132 such that the contact member 132 is capable of undergoing relative rotation on the shaft 134. As illustrated in FIGS. 3 and 4, the shaft 134 is a substantially round columnar member and is received at the two axial ends thereof by a pair of receiving portions 138. The pair of receiving portions 138 are positioned opposite each other in the Y direction, i.e., the short-side direction of the base member 42. The pair of receiving portions 138 receive the shaft 134 such that the shaft 134 is rotatable about the Y axis and is movable in the direction parallel to the direction of light emission. More specifically, the contact member 132 is positioned between the pair of receiving portions 138 that receive the shaft 134.

As illustrated in FIG. 4, the pair of receiving portions 138 are the walls of elongated holes provided respectively in a pair of supporting plates 140, which are provided across the contact member 132 from each other in the Y direction. The elongated holes are elongated in the Z direction. Therefore, the shaft 134 supported at the two axial ends thereof is rotatable and is movable in the direction parallel to the direction of light emission. The two axial ends of the shaft 134 are provided with respective stoppers (not illustrated) that prevent the shaft 134 from coming off.

Referring to FIG. 2, the movable member 136 comes into contact with the shaft 134 and causes the shaft 134 to move in the direction parallel to the direction of light emission from the light-emitting unit 41.

The movable member 136 is movable in the X direction. The position adjusting unit 130 includes a feeding member 142 and a drive source 144. The movable member 136 is caused to move in the X direction with the aid of the feeding member 142. The feeding member 142 according to the present exemplary embodiment is a feed screw serving as an exemplary screw member. The feeding member 142 extends through a connecting plate 146, which connects the X-direction ends of the pair of supporting plates 140 to each other. The drive source 144 is connected to one axial end of the feeding member 142. The drive source 144 drives the feeding member 142 to rotate. While the drive source 144 according to the present exemplary embodiment is, for example, an electric motor, the present disclosure is not limited to such a case. The drive source 144 is attached to an attaching plate 148, which projects from the connecting plate 146 on one side in the X direction (the left side in FIG. 2, i.e., the near side in the device-depth direction). In the position adjusting unit 130 according to the present exemplary embodiment, the pair of supporting plates 140, the connecting plate 146, and the attaching plate 148 form a housing 131. The housing 131 is attached to a frame (not illustrated) included in the image forming section 14.

The movable member 136 has a converting portion 150, which converts a moving force in the X direction that is exerted by the feeding member 142 into a moving force that causes the shaft 134 to move in the direction parallel to the direction of light emission. Specifically, the converting portion 150 is a slope angled with respect to the X direction and provided at a part of the movable member 136 that comes into contact with the shaft 134. More specifically, referring to FIG. 4, the converting portion 150 included in the movable member 136 is one of a pair of converting portions 150 (a pair of slopes). The pair of converting portions 150 are positioned across the contact member 132 from each other and are in contact with the shaft 134 on the respective sides in the axial direction of the shaft 134. The movable member 136 according to the present exemplary embodiment has, for example, a cubic shape with a groove 136A, which extends in the X direction and is provided in a portion facing the contact member 132. A part of the outer circumference of the contact member 132 is to be received by the groove 136A. That is, the pair of converting portions 150 are positioned across the groove 136A of the movable member 136 from each other.

Referring to FIG. 2, the base member 42 is pressed by the pressing unit 129 toward the position adjusting unit 130. The pressing unit 129 is positioned across the base member 42 from the position adjusting unit 130. That is, the base member 42 is held and pressed in the Z direction between the position adjusting unit 130 and the pressing unit 129. When the movable member 136 moves in the X direction, the slopes serving as the converting portions 150 move on the outer circumferential surface of the shaft 134 and exert a moving force that causes the shaft 134 to move in the Z direction. The moving force in the Z direction thus applied to the shaft 134 is transmitted through the contact member 132 to the base member 42, whereby a pressing protrusion 129A, included in the pressing unit 129, is pushed into the pressing unit 129. Consequently, the base member 42 is moved in the Z direction, that is, the position of the base member 42 is adjusted. Referring to FIGS. 2 to 4, the pressing unit 129 according to the present exemplary embodiment includes the pressing protrusion 129A, a housing 129B, and an urging member 129C. The pressing protrusion 129A comes into contact with the back surface, 42B, of the base member 42 and presses the base member 42 in the direction of light emission. The housing 129B allows the pressing protrusion 129A to be housed therein. The urging member 129C is provided inside the housing 129B and urges the pressing protrusion 129A in the direction of light emission. The urging member 129C may be, for example, a coil spring. However, the present disclosure is not limited to such a configuration. The coil spring employed as the urging member 129C may be replaced with an electrical actuator or the like.

Referring to FIG. 4, seen in the direction of light emission, the feeding member 142 extending through the movable member 136 coincides with the contact member 132.

The coefficient of friction between the contact member 132 and the base member 42 is smaller than the coefficient of friction between the shaft 134 and the contact member 132. Specifically, since the contact member 132 according to the present exemplary embodiment is a ball bearing, the contact member 132 undergoes relative rotation on the shaft 134 before friction occurs between the contact member 132 and the base member 42.

The pair of supporting plates 140 are connected to each other at the respective Z-direction ends thereof by a connecting plate 147. The connecting plate 147 has an opening 147A, through which a part of the outer circumference of the contact member 132 projects to the outside. A point at the part of the contact member 132 that projects to the outside is in contact with the front surface 42A of the base member 42.

The drive source 144 is positioned across the position adjusting unit 130 from the positioning member 160 in the X direction (the drive source 144 is positioned on the near side in the device-depth direction).

Referring to FIG. 5, the light-emitting unit 41 according to the present exemplary embodiment includes measuring devices 162, which are provided adjacent to corresponding ones of the light emitters 44 in the width direction of the base member 42 (the Y direction). The measuring devices 162 each measure the distance from the light-emitting unit 41 to the surface of the photoconductor drum 32.

In the image forming apparatus 10 according to the present exemplary embodiment, the distance from the light-emitting unit 41 to the surface of the photoconductor drum 32 is measured by each of the measuring devices 162 provided at the two respective ends of the base member 42, and respective pieces of information acquired by the measurement are transmitted to a controller (not illustrated). The controller activates the position adjusting units 130 with reference to the respective pieces of information acquired by the measurement. Specifically, the controller adjusts the amounts of driving by the drive sources 144 with reference to the respective pieces of information acquired by the measurement. When the values acquired by the measuring devices 162 fall within a preset range, the controller stops the operation of the drive sources 144. The adjustment of the position of the light-emitting unit 41 by using the position adjusting units 130 may be executed when the light-emitting unit 41 is attached to the photoconductor drum 32 or after a predetermined period of time elapses from when the light-emitting unit 41 is attached to the photoconductor drum 32.

Now, a configuration featured in the image forming apparatus 10 according to the present exemplary embodiment will be described.

In the image forming apparatus 10 illustrated in FIG. 1, the direction of detaching and attaching of the light-emitting unit 41 is different between that for the toner-image-forming units 22Y and 22M and that for the toner-image-forming units 22C and 22K. Specifically, the direction of detaching and attaching of the light-emitting unit 41Y from and to the toner-image-forming unit 22Y is the same as the direction of detaching and attaching of the light-emitting unit 41M from and to the toner-image-forming unit 22M. Furthermore, the direction of detaching and attaching of the light-emitting unit 41C from and to the toner-image-forming unit 22C is the same as the direction of detaching and attaching of the light-emitting unit 41K from and to the toner-image-forming unit 22K. However, the direction of detaching and attaching of the light-emitting unit 41Y from and to the toner-image-forming unit 22Y is different from the direction of detaching and attaching of the light-emitting unit 41C from and to the toner-image-forming unit 22C.

The toner-image-forming units 22Y and 22M according to the present exemplary embodiment are exemplary first image forming units according to the present disclosure. Correspondingly, the photoconductor drums 32Y and 32M according to the present exemplary embodiment are exemplary first image carriers according to the present disclosure. Furthermore, the light-emitting units 41Y and 41M according to the present exemplary embodiment are exemplary first light-emitting units according to the present disclosure.

On the other hand, the toner-image-forming units 22C and 22K according to the present exemplary embodiment are exemplary second image forming units according to the present disclosure. Correspondingly, the photoconductor drums 32C and 32K according to the present exemplary embodiment are exemplary second image carriers according to the present disclosure. Furthermore, the light-emitting units 41C and 41K according to the present exemplary embodiment are exemplary second light-emitting units according to the present disclosure.

Referring to FIG. 1, in the image forming apparatus 10 according to the present exemplary embodiment, the toner-image-forming units 22Y and 22M are provided on the upper side of the transfer belt 24. Specifically, the toner-image-forming units 22Y and 22M are arranged side by side at an interval therebetween along the horizontal portion 24A of the transfer belt 24.

In the image forming apparatus 10 according to the present exemplary embodiment, as illustrated in FIG. 1, the toner-image-forming units 22C and 22K are provided on the lower side of the transfer belt 24. Specifically, the toner-image-forming units 22C and 22K are arranged side by side at an interval therebetween along the angled portion 24B of the transfer belt 24.

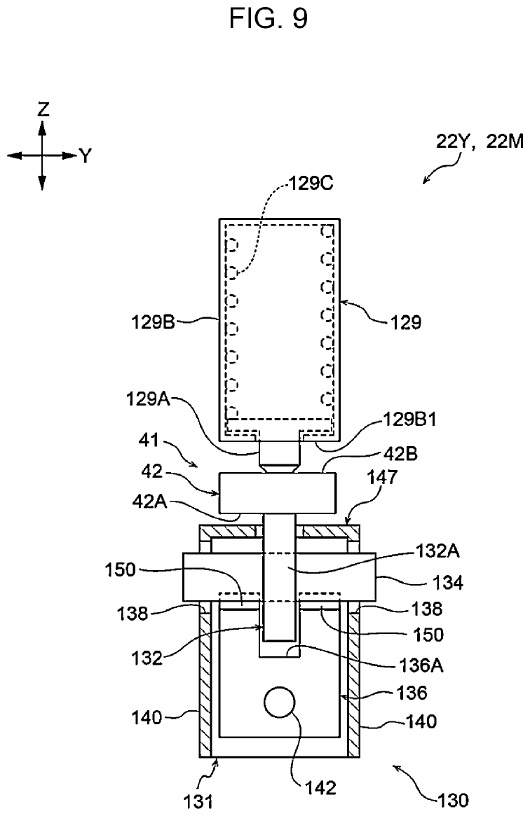

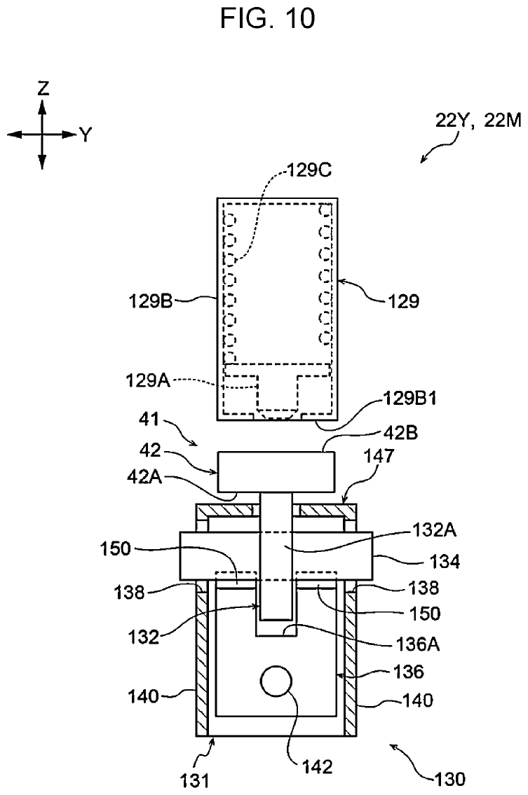

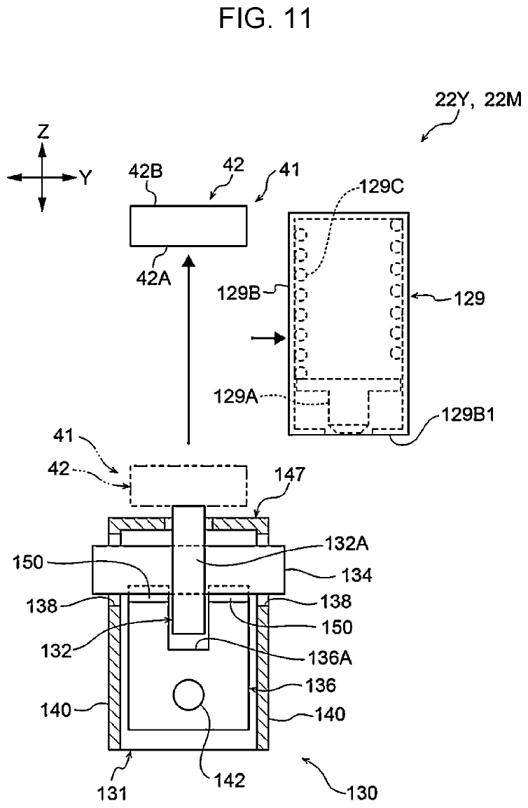

The light-emitting units 41Y and 41M are detachable from the respective toner-image-forming units 22Y and 22M by being moved in a first direction, in which the light-emitting unit 41Y and 41M move away from the respective photoconductor drums 32Y and 32M. Herein, the first direction for the toner-image-forming unit 22Y according to the present exemplary embodiment refers to, for example, a direction opposite to the direction of light emission from the light-emitting unit 41Y. The first direction for the toner-image-forming unit 22M according to the present exemplary embodiment refers to the direction opposite to the direction of light emission from the light-emitting unit 41M and heading upward in the direction of gravity. Specifically, to detach the light-emitting unit 41Y from the toner-image-forming unit 22Y, the urging members 129C included in the pressing units 129 that are positioned as illustrated in FIG. 9 are compressed. That is, the spring forces applied to the light-emitting unit 41Y are removed. Thus, as illustrated in FIG. 10, the light-emitting unit 41Y is disabled from being held and pressed between the pressing units 129 and the position adjusting units 130. In other words, the light-emitting unit 41Y is ready to be disabled from being positioned with respect to the photoconductor drum 32Y. In this state, the light-emitting unit 41Y is temporarily supported by the contact members 132 included in the respective position adjusting units 130. Then, as illustrated in FIG. 11, the pressing units 129 are retracted from the path of movement of the light-emitting unit 41Y. Herein, the path of movement of the light-emitting unit 41Y extends in the direction of detaching and attaching of the light-emitting unit 41Y, i.e., the first direction, which is the direction opposite to the direction of light emission from the light-emitting unit 41Y. After the pressing units 129 are retracted, the light-emitting unit 41Y is moved in the first direction. Thus, the light-emitting unit 41Y is detached from the toner-image-forming unit 22Y.

The process of detaching the light-emitting unit 41M from the toner-image-forming unit 22M is the same as the process of detaching the light-emitting unit 41Y from the toner-image-forming unit 22Y. Therefore, description of the process of detaching the light-emitting unit 41M from the toner-image-forming unit 22M is omitted.

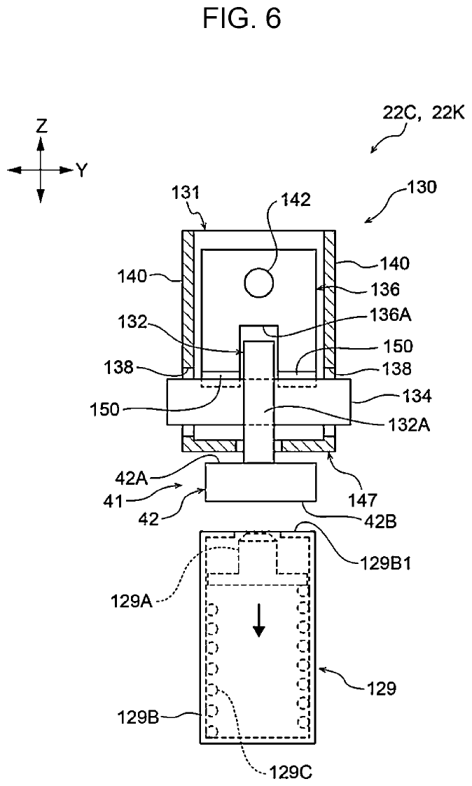

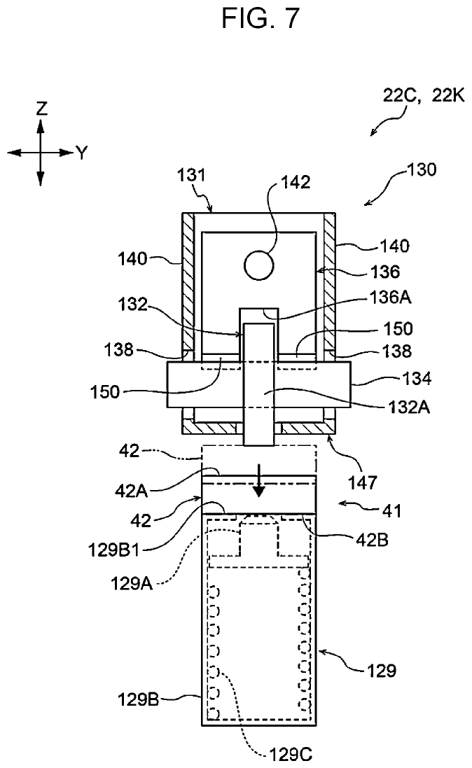

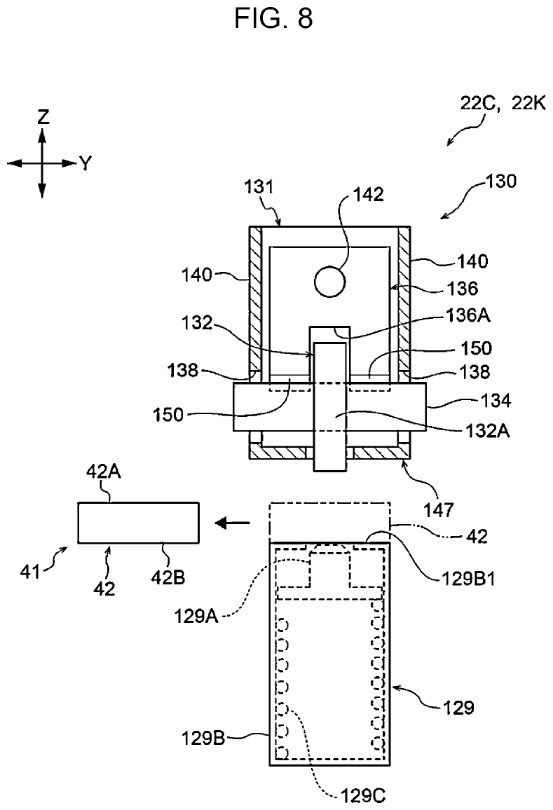

The light-emitting units 41C and 41K are detachable from the respective toner-image-forming units 22C and 22K by being moved in a second direction, in which the light-emitting units 41C and 41K are moved away from the respective photoconductor drums 32C and 32K, and, at a predetermined position in the second direction, being further moved in a direction intersecting the second direction. Herein, the second direction for the toner-image-forming unit 22C according to the present exemplary embodiment refers to, for example, a direction opposite to the direction of light emission from the light-emitting unit 41C. The second direction for the toner-image-forming unit 22K according to the present exemplary embodiment refers to a direction opposite to the direction of light emission from the light-emitting unit 41K and heading downward in the direction of gravity. Specifically, to detach the light-emitting unit 41C from the toner-image-forming unit 22C, the urging members 129C included in the pressing units 129 are compressed as illustrated in FIG. 6. That is, the spring forces applied to the light-emitting unit 41C are removed. Thus, as illustrated in FIG. 7, the light-emitting unit 41C is disabled from being held and pressed between the pressing units 129 and the position adjusting units 130. In other words, the light-emitting unit 41C is ready to be disabled from being positioned with respect to the photoconductor drum 32C. In this state, the light-emitting unit 41C moves in the second direction and comes into contact with an end face, 129B1, of the housing 129B of each of the pressing units 129. In other words, the light-emitting unit 41C is temporarily supported by the end faces 129B1 of the housings 129B of the pressing units 129. Seen in the X direction (as illustrated in FIG. 8), the light-emitting unit 41C in such a state is moved in a direction intersecting the second direction. Thus, the light-emitting unit 41C is detached from the toner-image-forming unit 22C. Specifically, the light-emitting unit 41C that is at a predetermined position in the second direction (the position where the light-emitting unit 41C is temporarily supported by the housing 129B) is detachable from the toner-image-forming unit 22C by being moved in a direction intersecting the second direction, i.e., in the Y direction in the present exemplary embodiment.

The process of detaching the light-emitting unit 41C from the toner-image-forming unit 22C is the same as the process of detaching the light-emitting unit 41K from the toner-image-forming unit 22K. Therefore, description of the process of detaching the light-emitting unit 41K from the toner-image-forming unit 22K is omitted.

Now, functions exerted by the present exemplary embodiment will be described.

In the image forming apparatus 10 including the exposure devices 40 according to the present exemplary embodiment, the direction of detaching and attaching of the light-emitting units 41Y and 41M from and to the toner-image-forming units 22Y and 22M is different from the direction of detaching and attaching of the light-emitting units 41C and 41K from and to the toner-image-forming units 22C and 22K.

In the image forming apparatus 10, the light-emitting units 41Y and 41M are detachable from the respective toner-image-forming units 22Y and 22M by being moved in the first direction in which the light-emitting units 41Y and 41M are moved away from the respective photoconductor drums 32Y and 32M. Furthermore, the light-emitting units 41C and 41K are detachable from the respective toner-image-forming units 22C and 22K by being moved in the second direction in which the light-emitting units 41C and 41K are moved away from the respective photoconductor drums 32C and 32K and, at a predetermined position in the second direction, being further moved in the direction intersecting the second direction.

In the image forming apparatus 10, the first direction is the direction opposite to the direction of light emission from the light-emitting units 41Y and 41M, and the second direction is the direction opposite to the direction of light emission from the light-emitting units 41C and 41K.

In the image forming apparatus 10, seen in the X direction, the light-emitting units 41C and 41K are detachable from the toner-image-forming units 22C and 22K by being moved in the direction intersecting the second direction at respective predetermined positions in the second direction.

In the image forming apparatus 10, the light-emitting units 41Y and 41M are detachable from the toner-image-forming units 22Y and 22M by being moved in a direction parallel to the direction of gravity. Furthermore, the light-emitting units 41C and 41K are detachable from the toner-image-forming units 22C and 22K by being moved in a direction parallel to the direction of gravity.

In the image forming apparatus 10, the toner-image-forming units 22Y and 22M are provided on the upper side of the transfer belt 24, and the first direction in which the light-emitting units 41Y and 41M are detachable from the toner-image-forming units 22Y and 22M is heading upward in the direction of gravity. Furthermore, the toner-image-forming units 22C and 22K are provided on the lower side of the transfer belt 24, and the second direction in which the light-emitting units 41C and 41K are detachable from the toner-image-forming units 22C and 22K is heading downward in the direction of gravity.

In the image forming apparatus 10, the toner-image-forming units 22Y and 22M are arranged along the horizontal portion 24A of the transfer belt 24, and the toner-image-forming units 22C and 22K are arranged along the angled portion 24B of the transfer belt 24.

While the light-emitting units 41Y and 41M of the toner-image-forming units 22Y and 22M according to the above exemplary embodiment are detachable by being moved in the first direction, the present disclosure is not limited to such a configuration. For example, as with the case of the toner-image-forming units 22C and 22K, the toner-image-forming units 22Y and 22M may be configured such that the light-emitting units 41Y and 41M are detachable by first being moved in the first direction and then, at a predetermined position, being moved in a direction intersecting the first direction.

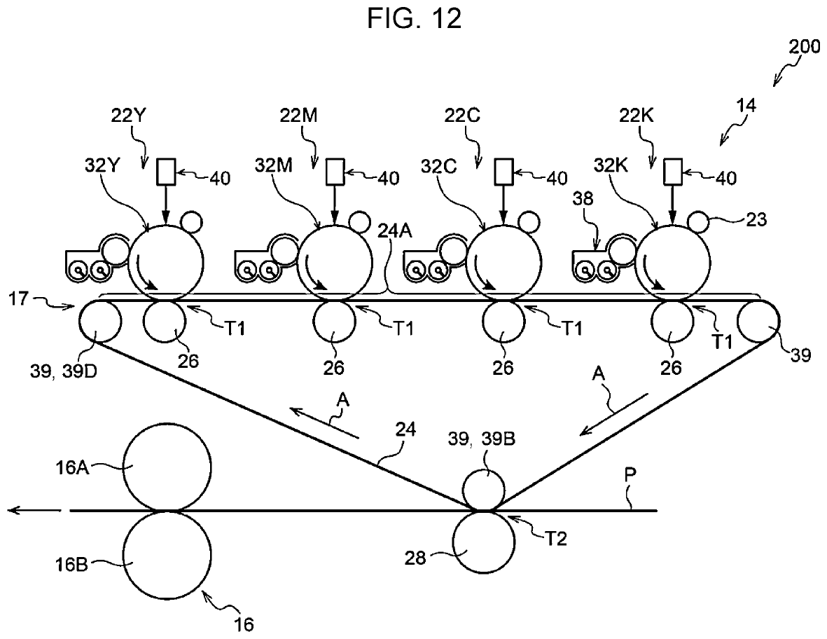

While the image forming apparatus 10 according to the above exemplary embodiment includes, as illustrated in FIG. 1, the toner-image-forming units 22Y and 22M arranged along the horizontal portion 24A of the transfer belt 24 and the toner-image-forming units 22C and 22K arranged along the angled portion 24B of the transfer belt 24, the present disclosure is not limited to such a configuration. For example, an image forming apparatus 200 illustrated in FIG. 12 is also applicable, in which the toner-image-forming units 22Y, 22M, 22C, and 22K are arranged side by side at intervals from one another along the horizontal portion 24A of the transfer belt 24. In such a case, at least one of the toner-image-forming units 22Y, 22M, 22C, and 22K may be detachable by being moved in the first direction, whereas the remaining ones may be detachable by first being moved in the second direction and then in a direction intersecting the second direction.

While the above exemplary embodiment relates to a configuration in which the first direction for the toner-image-forming unit 22Y is the direction opposite to the direction of light emission from the light-emitting unit 41Y and heading upward in the direction of gravity, the present disclosure is not limited to such a configuration. The first direction for the toner-image-forming unit 22Y is not limited, as long as the direction in which the light-emitting unit 41Y moves away from the photoconductor drum 32Y is the first direction. For example, the first direction for the toner-image-forming unit 22Y may be heading upward in the direction of gravity, or may be heading upward in the direction of gravity while being at a predetermined angle (for example, +/−15 degrees) with respect to the direction opposite to the direction of light emission from the light-emitting unit 41Y. This also applies to the first direction for the toner-image-forming unit 22M.

While the above exemplary embodiment relates to a configuration in which the second direction for the toner-image-forming unit 22C is the direction opposite to the direction of light emission from the light-emitting unit 41C and heading downward in the direction of gravity, the present disclosure is not limited to such a configuration. For example, the second direction for the toner-image-forming unit 22C is not limited, as long as the direction in which the light-emitting unit 41C moves away from the photoconductor drum 32C is the second direction. For example, the second direction for the toner-image-forming unit 22C may be heading downward in the direction of gravity, or may be heading downward in the direction of gravity while being at a predetermined angle (for example, +/−15 degrees) with respect to the direction opposite to the direction of light emission from the light-emitting unit 41C. This also applies to the second direction for the toner-image-forming unit 22K. In a configuration in which the light-emitting unit 41C is first moved in the second direction and is then moved in a direction intersecting the second direction, the intersecting direction may be, for example, any of the X direction, the Y direction, and the Z direction or may be a direction defined by a combination of components in the foregoing directions.

While the image forming apparatus according to the above exemplary embodiment relates to a configuration in which three light emitters are provided on a base member, the present disclosure is not limited to such a configuration. For example, any of the following is applicable: a configuration in which one light emitter is provided on a base member, a configuration in which two light emitters are provided on a base member, and a configuration in which four or more light emitters are provided on a base member. The positions of the plurality of light emitters provided on the base member are defined in any way.

The features of the image forming apparatus according to the above exemplary embodiment may also be applied to elements intended for photolithography, which is performed in the following: for example, the formation of a color filter in a process of manufacturing a liquid-crystal display (LCD), exposure to be performed on a dry film resist (DFR) in a process of manufacturing a thin-film transistor (TFT), exposure to be performed on a dry film resist (DFR) in a process of manufacturing a plasma display panel (PDP), exposure to be performed on a photosensitive material such as photoresist in a process of manufacturing a semiconductor device, exposure to be performed on a photosensitive material such as photoresist in platemaking for printing such as gravure printing other than offset printing, and exposure to be performed on a photosensitive material in a process of manufacturing clock components. Photolithography refers to a technique in which pattern exposure is performed on a surface of a substance over which a photosensitive material is provided, whereby a pattern including regions that have been exposed to light and regions that have not been exposed to light is obtained.

The image forming apparatus described above may be used with either a photon-mode photosensitive material, with which information is directly recorded by exposure, or a heat-mode photosensitive material, with which information is recorded with heat generated by exposure. The light source of the image forming apparatus may be an LED device or a laser device, depending on the object of exposure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus comprising:
a first image forming unit including:
a rotatable first image carrier; and
a first light-emitting unit including:
a first base member extending in an axial direction of the first image carrier; and
a plurality of first light-emitting devices provided on the first base member and being configured to apply light to an outer circumferential surface of the first image carrier; and
a second image forming unit including:
a rotatable second image carrier; and
a second light-emitting unit including:
a second base member extending in an axial direction of the second image carrier; and
a plurality of second light-emitting devices, provided on the second base member and being configured to apply light to an outer circumferential surface of the second image carrier,
wherein a direction of detaching and attaching of the first light-emitting unit from and to the first image forming unit and a direction of detaching and attaching of the second light-emitting unit from and to the second image forming unit are different from each other.

2. The image forming apparatus according to claim 1, wherein the first light-emitting unit is detachable from the first image forming unit by being moved in a first direction in which the first light-emitting unit moves away from the first image carrier, and
wherein the second light-emitting unit is detachable from the second image forming unit by being moved in a second direction in which the second light-emitting unit moves away from the second image carrier and, at a predetermined position in the second direction, being further moved in a direction intersecting the second direction.

3. The image forming apparatus according to claim 2, wherein the first direction is a direction opposite to a direction of light emission from the first light-emitting unit, and
wherein the second direction is a direction opposite to a direction of light emission from the second light-emitting unit.

4. The image forming apparatus according to claim 3, wherein, seen in an axial direction of the second image carrier, the second light-emitting unit that is at the predetermined position in the second direction is detachable from the second image forming unit by being moved in the direction intersecting the second direction.

5. The image forming apparatus according to claim 1, further comprising:
a transfer member configured to transfer images from the first image forming unit and the second image forming unit,
wherein the first image forming unit is one of a plurality of first image forming units,
wherein the second image forming unit is one of a plurality of second image forming units,
wherein either the plurality of first image forming units or the plurality of second image forming units is provided on an upper side of the transfer member,
wherein an other of the plurality of first image forming units and the plurality of second image forming units is provided on a lower side of the transfer member,
wherein the first light-emitting units are detachable from the first image forming units by being moved in a direction parallel to a direction of gravity, and
wherein the second light-emitting units are detachable from the second image forming units by being moved in a direction parallel to the direction of gravity.

6. The image forming apparatus according to claim 2, further comprising:
a transfer member to which images are to be transferred from the first image forming unit and the second image forming unit,
wherein the first image forming unit is one of a plurality of first image forming units,
wherein the second image forming unit is one of a plurality of second image forming units,
wherein either the plurality of first image forming units or the plurality of second image forming units is provided on an upper side of the transfer member,
wherein an other of the plurality of first image forming units and the plurality of second image forming units is provided on a lower side of the transfer member,
wherein the first light-emitting units are detachable from the first image forming units by being moved in a direction parallel to a direction of gravity, and
wherein the second light-emitting units are detachable from the second image forming units by being moved in a direction parallel to the direction of gravity.

7. The image forming apparatus according to claim 3, further comprising:
a transfer member to which images are to be transferred from the first image forming unit and the second image forming unit,
wherein the first image forming unit is one of a plurality of first image forming units,
wherein the second image forming unit is one of a plurality of second image forming units,
wherein either the plurality of first image forming units or the plurality of second image forming units is provided on an upper side of the transfer member,
wherein an other of the plurality of first image forming units and the plurality of second image forming units is provided on a lower side of the transfer member,
wherein the first light-emitting units are detachable from the first image forming units by being moved in a direction parallel to a direction of gravity, and
wherein the second light-emitting units are detachable from the second image forming units by being moved in a direction parallel to the direction of gravity.

8. The image forming apparatus according to claim 4, further comprising:
a transfer member to which images are to be transferred from the first image forming unit and the second image forming unit,
wherein the first image forming unit is one of a plurality of first image forming units,
wherein the second image forming unit is one of a plurality of second image forming units,
wherein either the plurality of first image forming units or the plurality of second image forming units is provided on an upper side of the transfer member,
wherein an other of the plurality of first image forming units and the plurality of second image forming units is provided on a lower side of the transfer member,
wherein the first light-emitting units are detachable from the first image forming units by being moved in a direction parallel to a direction of gravity, and
wherein the second light-emitting units are detachable from the second image forming units by being moved in a direction parallel to the direction of gravity.

9. The image forming apparatus according to claim 6, wherein the plurality of first image forming units are provided on the upper side of the transfer member,
wherein the plurality of second image forming units are provided on the lower side of the transfer member,
wherein the first direction is heading upward in the direction of gravity, and
wherein the second direction is heading downward in the direction of gravity.

10. The image forming apparatus according to claim 5, wherein the transfer member includes a horizontal portion that extends in a horizontal direction, and an angled portion that is angled with respect to a vertical direction,
wherein the plurality of first image forming units are arranged at intervals from one another along the horizontal portion, and
wherein the plurality of second image forming units are arranged at intervals from one another along the angled portion.

11. The image forming apparatus according to claim 6, wherein the transfer member includes a horizontal portion that extends in a horizontal direction, and an angled portion that is angled with respect to a vertical direction,
wherein the plurality of first image forming units are arranged at intervals from one another along the horizontal portion, and
wherein the plurality of second image forming units are arranged at intervals from one another along the angled portion.

12. The image forming apparatus according to claim 7, wherein the transfer member includes a horizontal portion that extends in a horizontal direction, and an angled portion that is angled with respect to a vertical direction,
wherein the plurality of first image forming units are arranged at intervals from one another along the horizontal portion, and
wherein the plurality of second image forming units are arranged at intervals from one another along the angled portion.

13. The image forming apparatus according to claim 8, wherein the transfer member includes a horizontal portion that extends in a horizontal direction, and an angled portion that is angled with respect to a vertical direction,
wherein the plurality of first image forming units are arranged at intervals from one another along the horizontal portion, and
wherein the plurality of second image forming units are arranged at intervals from one another along the angled portion.

14. The image forming apparatus according to claim 9, wherein the transfer member includes a horizontal portion that extends in a horizontal direction, and an angled portion that is angled with respect to a vertical direction,
wherein the plurality of first image forming units are arranged at intervals from one another along the horizontal portion, and
wherein the plurality of second image forming units are arranged at intervals from one another along the angled portion.

15. An image forming apparatus comprising:
a first means for forming an image including:
a rotatable first means for carrying an image; and
a first light-emitting means including:
a first means for a base extending in an axial direction of the first means for carrying an image; and
a plurality of first means for emitting light provided on the first means for a base and being configured to apply light to an outer circumferential surface of the first means for carrying an image; and
a second means for forming an image including:
a rotatable second means for carrying an image; and
a second means for emitting light including:
a second means for a base extending in an axial direction of the second means for carrying an image; and
a plurality of second means for emitting light provided on the second means for a base and being configured to apply light to an outer circumferential surface of the second means for carrying an image,
wherein a direction of detaching and attaching of the first means for emitting light from and to the first means for forming an image and a direction of detaching and attaching of the second means for emitting light from and to the second means for forming an image are different from each other.
